(19) United States
(12) Patent Application Publication
(10) Pub. No.: US 2025/0058369 A1
(43) Pub. Date: Feb. 20, 2025

(54) CONNECTOR CRIMPING DEVICE

(71) Applicant: Tyco Electronics (Shanghai) Co., Ltd., Shanghai (CN)

(72) Inventors: Jianguo (Thomas) Yang, Shanghai (CN); Lijiong Zhang, Shanghai (CN)

(73) Assignee: Tyco Electronics (Shanghai) Co., Ltd., Shanghai (CN)

(21) Appl. No.: 18/807,255

(22) Filed: Aug. 16, 2024

(30) Foreign Application Priority Data
Aug. 16, 2023 (CN) 202311038258.6

(51) Int. Cl. B21D 39/04

(52) U.S. Cl. CPC B21D 39/048

(57) ABSTRACT

A connector crimping device includes a first movable block movable along a first direction and formed with a sliding slot extending along the first direction, a second movable block movable along the sliding slot, and an installation shaft rotatably installed to the first movable block and passing through the second movable block. The installation shaft includes a first shaft portion rotationally mated with the first movable block and having a first central axis extending along a second direction perpendicular to the first direction. The installation shaft has a second shaft portion rotationally mated with the second movable block and having a second central axis extending along the second direction. The second central axis is offset by a predetermined distance from the first central axis. A movement distance of the second movable block relative to the first movable block in the first direction is adjustable by rotating the installation shaft.

### CROSS-REFERENCE TO RELATED APPLICATION

This application claims the benefit of the filing date under 35 U.S.C. § 119 (a)-(d) of Chinese Patent Application No. 202311038258.6, filed on Aug. 16, 2023.

### FIELD OF THE INVENTION

The present invention relates to a connector crimping device, in particular to a connector crimping device for crimping a terminal of a connector onto a cable.

### BACKGROUND OF THE INVENTION

A connector crimping device is usually used to crimp a terminal of a connector onto a cable. The connector typically includes a housing, a terminal module, and a cable. Before crimping, the terminal module is pre-installed into the housing and the cable is inserted into the housing. During crimping, the connector crimping device pushes the terminal module upwards, causing the terminal on the terminal module to puncture the cable sheath and be crimped onto the cable conductor.

A crimping height of the connector crimping device is fixed. Each connector crimping device can thus only crimp one type of connector product and cannot crimp multiple different types of connector products with different crimping heights.

### SUMMARY OF THE INVENTION

A connector crimping device includes a first movable block movable along a first direction and formed with a sliding slot extending along the first direction, a second movable block movable along the sliding slot, and an installation shaft rotatably installed to the first movable block and passing through the second movable block. The installation shaft includes a first shaft portion rotationally mated with the first movable block and having a first central axis extending along a second direction perpendicular to the first direction. The installation shaft has a second shaft portion rotationally mated with the second movable block and having a second central axis extending along the second direction. The second central axis is offset by a predetermined distance from the first central axis. A movement distance of the second movable block relative to the first movable block in the first direction is adjustable by rotating the installation shaft.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector crimping device according to an exemplary embodiment of the present invention;

FIG. 2 shows an illustrative exploded view of a connector crimping device as viewed from the front side according to an exemplary embodiment of the present invention;

FIG. 3 shows an illustrative exploded view of a connector crimping device according to an exemplary embodiment of the present invention when viewed from the rear side;

FIG. 4 shows an illustrative assembly view of the first movable block, second movable block, and installation shaft of a connector crimping device according to an exemplary embodiment of the present invention;

FIG. 5 shows an illustrative exploded view of the first movable block, second movable block, and installation shaft of a connector crimping device according to an exemplary embodiment of the present invention;

FIG. 6 shows an illustrative view of the installation shaft of a connector crimping device according to an exemplary embodiment of the present invention;

FIG. 7 shows an illustrative perspective view of a connector crimping device according to an exemplary embodiment of the present invention when viewed from the rear, where the first movable block is not shown;

FIG. 8 shows an illustrative assembly view of the installation shaft, mounting plate, dial, rotating component, and locking member of the connector crimping device according to an exemplary embodiment of the present invention when viewed from the front side;

FIG. 9 shows an illustrative assembly view of the installation shaft, installation plate, dial, rotating component, and locking member of the connector crimping device according to an exemplary embodiment of the present invention when viewed from the rear;

FIG. 10 shows an illustrative exploded view of the installation shaft, installation plate, dial, rotating component, and locking member of the connector crimping device according to an exemplary embodiment of the present invention when viewed from the front side; and

FIG. 11 shows an illustrative exploded view of the installation shaft, installation plate, dial, rotating component, and locking member of the connector crimping device according to an exemplary embodiment of the present invention when viewed from the rear.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

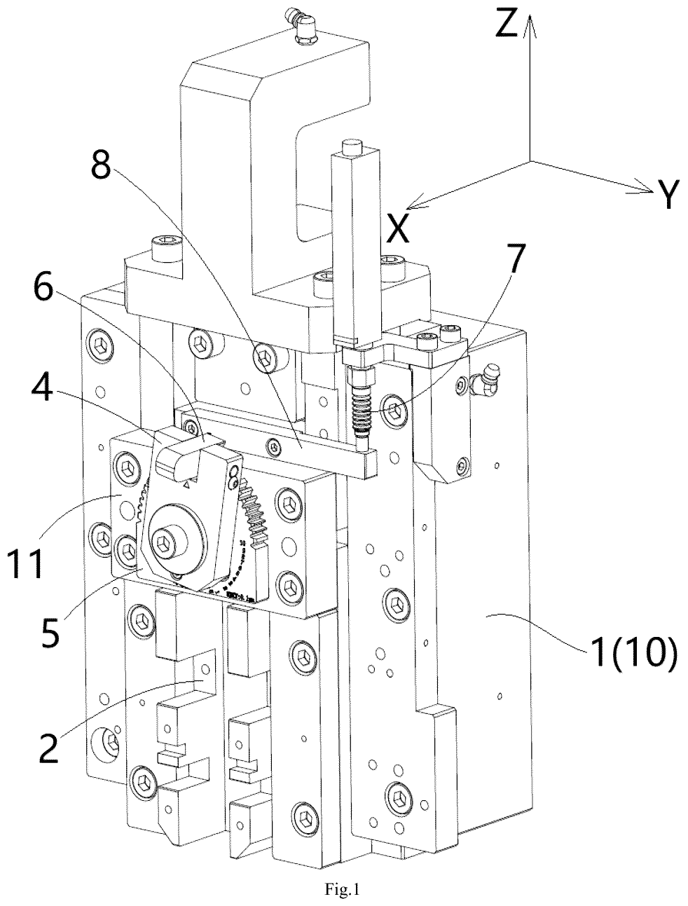

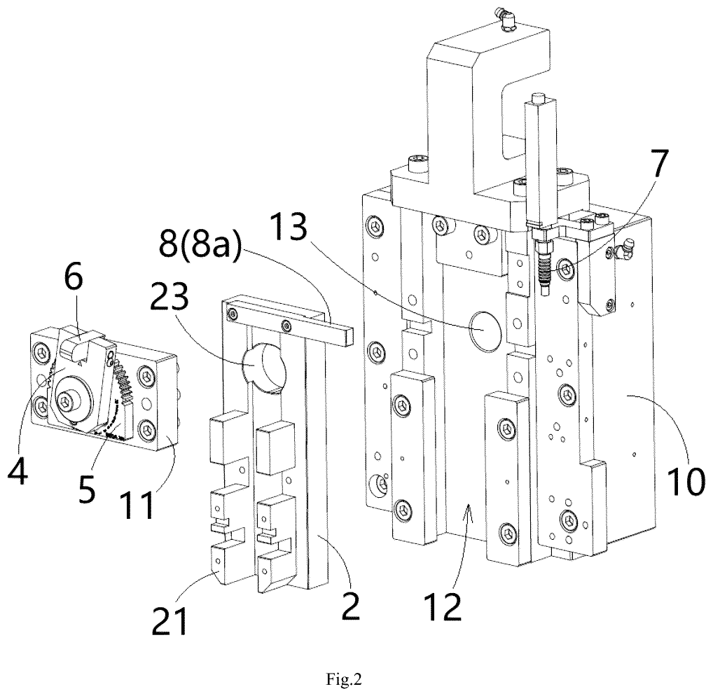

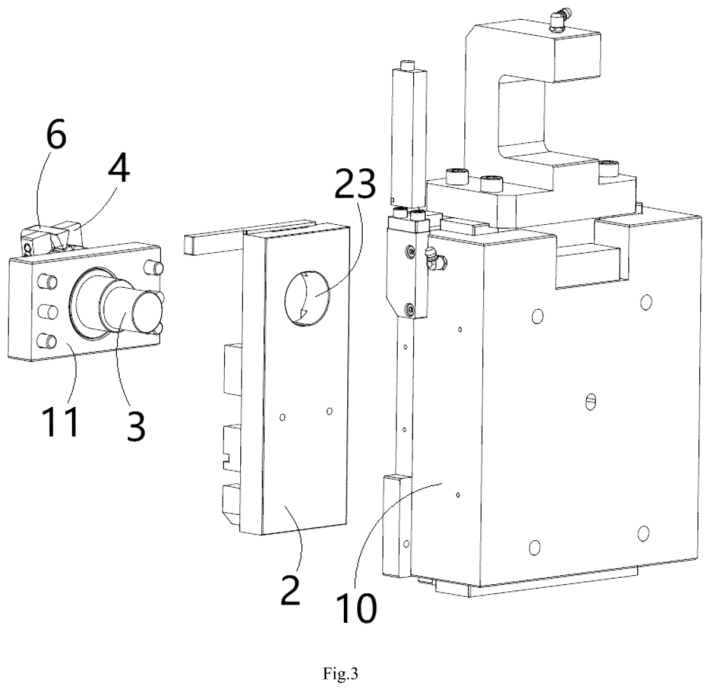

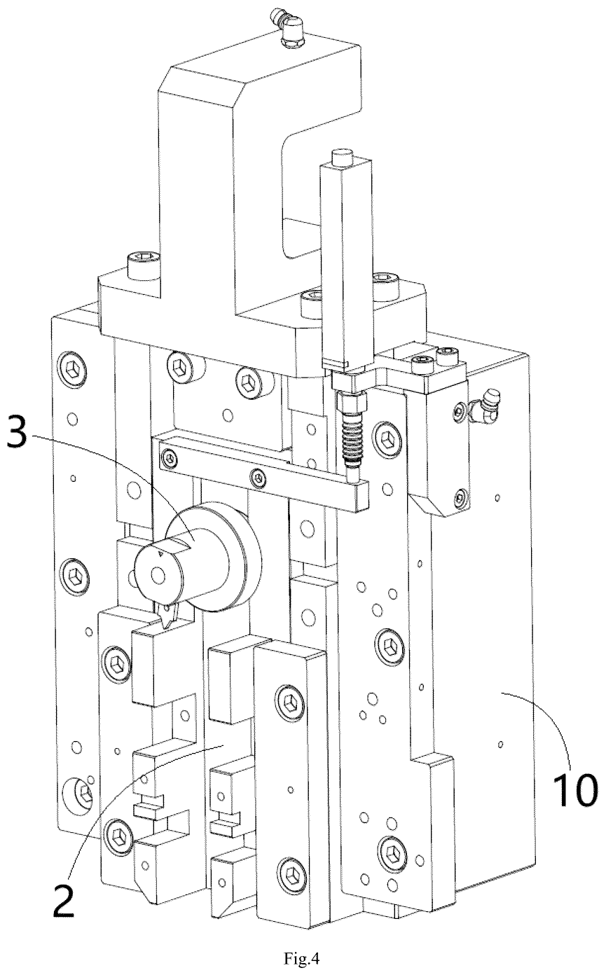

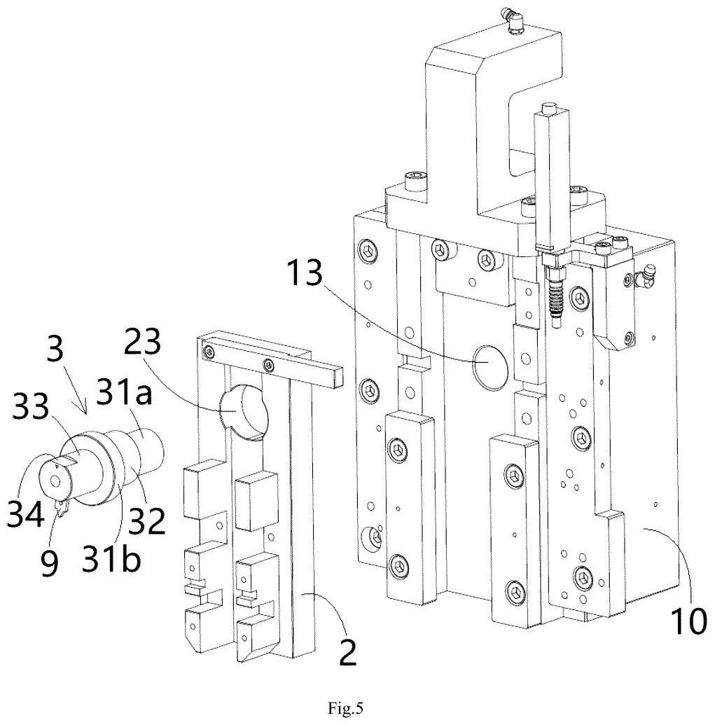

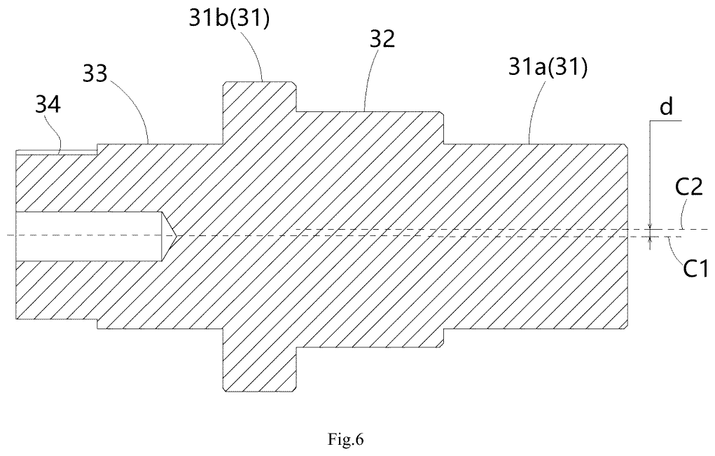

As shown in FIGS. 1 to 6, in an exemplary embodiment of the present invention, a connector crimping device is disclosed. The connector crimping device, as shown in FIGS. 1 to 3, includes a first movable block 1, a second movable block 2, and an installation shaft 3. The first movable block 1 can be moved along a first direction Z and is formed with a sliding slot 12 that extends along the first direction Z. The second movable block 2 is installed in the sliding slot 12 of the first movable block 1 and can be moved along the sliding slot 12, as shown in FIG. 2. The installation shaft 3 is rotatably installed onto the first movable block 1 and passes through the second movable block 2. The installation shaft 3 includes a first shaft portion 31 and a second shaft portion 32, as shown in FIG. 5. The first shaft portion 31 is rotatably mated with the first movable block 1 and has a first central axis C1 that extends along a second direction X perpendicular to the first direction Z, as shown in FIG. 6. The second shaft portion 32 is rotatably mated with the second movable block 2, and has a second central axis C2 that extends along the second direction X.

As shown in FIG. 6, in the illustrated embodiment, the second central axis C2 is offset by a predetermined distance d from the first central axis C1, so that the movement distance of the second movable block 2 relative to the first movable block 1 in the first direction Z can be adjusted by rotating the installation shaft 3. In this way, the crimping height of the connector crimping device in the first direction Z can be adjusted, so that the connector crimping device can be suitable for connector products with different crimping heights, expanding the application range of the connector crimping device.

In the illustrated embodiments, as shown in FIG. 1, the first direction Z is the vertical direction, and the second direction X is the horizontal direction perpendicular to the vertical direction. However, the present invention is not limited to the illustrated embodiments, and the first direction Z can also be in the horizontal direction.

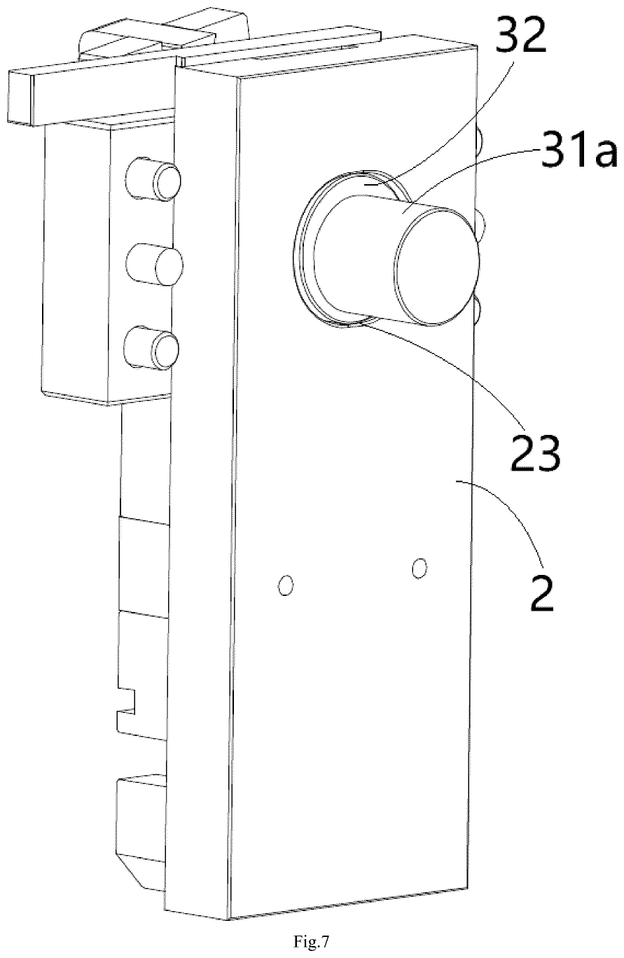

As shown in FIG. 2, in the illustrated embodiments, a pressing head 21 is provided on the second movable block 2, which is used to press against the terminal module of the connector to connect the terminal of the connector to the cable. In the illustrated embodiment, a second mounting hole 23 is formed in the second movable block 2, and the second shaft portion 32 is rotatably fitted in the second mounting hole 23, as shown in FIG. 7.

As shown in FIGS. 5 and 6, in the illustrated embodiments, the installation shaft 3 has front and rear ends opposite to each other in its axial direction. The first shaft portion 31 includes a first rear shaft portion 31a and a first front shaft portion 31b. The first rear shaft portion 31a is located at the rear end of the installation shaft 3. The first front shaft portion 31b is axially opposite to the first rear shaft portion 31a. The second shaft portion 32 is connected between the first rear shaft portion 31a and the first front shaft portion 31b.

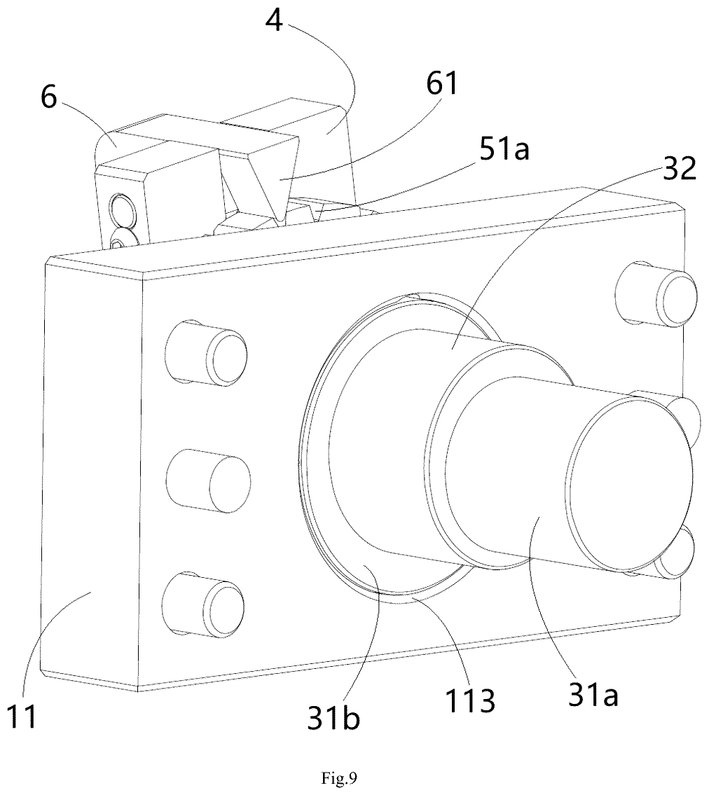

As shown in FIG. 2, in the illustrated embodiment, the first movable block 1 comprises a block body 10 and a mounting plate 11. The block body 10 is formed with a first rear mounting hole 13. The sliding slot 12 is formed on the block body 10. The mounting plate 11 is formed with a first front mounting hole 113, shown in FIG. 9, and is fixed to the block body 10. The first rear shaft portion 31a is rotatably fitted in the first rear mounting hole 13, while the first front shaft portion 31b is rotatably fitted in the first front mounting hole 113.

As shown in FIGS. 1, 2, and 8 to 11, in the illustrated embodiments, the connector crimping device further comprises a rotating component 4, which is fixed to the front end of the installation shaft 3 for driving the installation shaft 3 to rotate around the first central axis C1. The central axis of the front end of installation shaft 3 coincides with the first central axis C1.

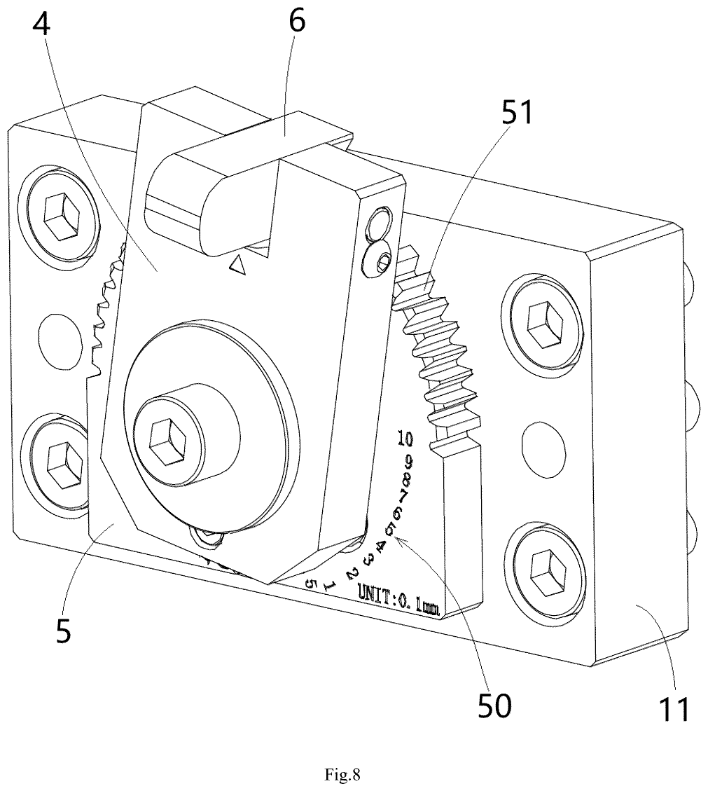

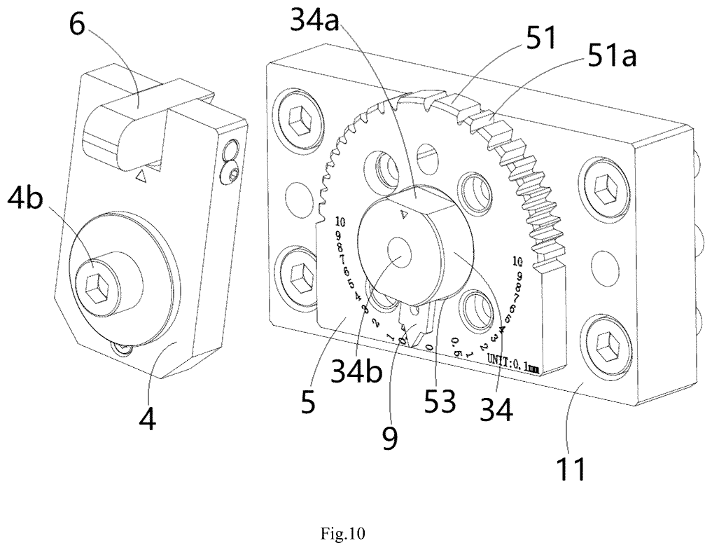

As shown in FIG. 10, in the illustrated embodiments, the connector crimping device further comprises a dial 5 and a pointer 9. The dial 5 is fixed to the outer side of the mounting plate 11 and is formed with a scale mark 50 on its surface, as shown in FIG. 8. The pointer 9 is fixed to the rotating component 4 or the installation shaft 3 to indicate the movement distance of the second movable block 2 relative to the first movable block 1. The front end of the installation shaft 3 passes through the dial 5 and is rotatably mated with the dial 5.

As shown in FIG. 10, in the illustrated embodiments, a third mounting hole 53 is formed in the dial 5, and the front end of the installation shaft 3 has a third shaft portion 33, shown in FIG. 6, that is rotatably fitted in the third mounting hole 53. The first front shaft portion 31b is axially connected between the third shaft portion 33 and the second shaft portion 32.

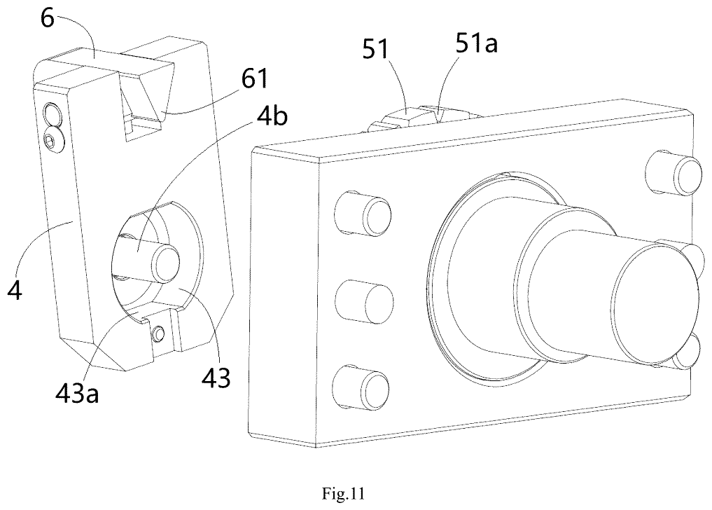

As shown in FIG. 6, in the illustrated embodiments, the front end of the installation shaft 3 also has a fourth shaft portion 34 that extends from the third mounting hole 53 of the dial 5. As shown in FIG. 11, an installation hole 43 that is mated with the fourth shaft portion 34 is formed in the rotating component 4. A first cutting plane 34a and a second cutting plane 43a are formed on the outer surface of the fourth shaft portion 34 and the inner surface of the installation hole 43, respectively, which are mutually matched, so that the rotating component 4 cannot be rotated relative to the installation shaft 3.

As shown in FIG. 10, in the illustrated embodiments, a threaded hole 34b is formed in the end face of the fourth shaft portion 34, and the connector crimping device further includes a threaded connecting member 4b. The threaded connecting member 4b passes through the rotating component 4 and is threaded into the threaded hole 34b to fix the rotating component 4 axially to the installation shaft 3.

As shown in FIGS. 8 to 11, in the illustrated embodiments, the connector crimping device further includes a locking member 6, which is used to lock the rotating component 4 to the mounting plate 11 or the dial 5. When the installation shaft 3 and rotating component 4 are rotated to a predetermined angle position relative to the dial 5, the locking member 6 locks the installation shaft 3 and the rotating component 4 at the predetermined angle position, so that the second movable block 2 is held at a predetermined position relative to the first movable block 1.

As shown in FIGS. 8 to 11, in the illustrated embodiments, a gear portion 51 is formed on the dial 5, and multiple tooth slots 51a on the gear portion 51 respectively correspond to multiple scale marks 50 on the dial 5. A locking tooth 61 is formed on the locking member 6, the locking member 6 is rotatably connected to the rotating component 4 and can be rotated between a locking position and an unlocking position.

As shown in FIGS. 8 and 9, in the illustrated embodiments, when the locking member 6 is rotated to the locking position, the locking tooth 61 is meshed with the corresponding tooth slot 51a on the gear portion 51 to lock the installation shaft 3 and the rotating component 4 at the predetermined angle position. When the locking member 6 is rotated to the unlocked position, the locking tooth 61 is detached from the tooth slot 51a on the gear section 51 to allow the installation shaft 3 and rotating component 4 to rotate relative to the dial 5. In various embodiments, the difference between adjacent scale marks 50 on dial 5 can be equal to 1 mm, 0.5 mm, 0.1 mm, or 0.05 mm. However, the present invention is not limited to the illustrated embodiments, for example, the difference between adjacent scale marks 50 on dial 5 can also be set to other values.

As shown in FIGS. 1 and 2, in the illustrated embodiments, the connector crimping device further comprises a sensor 7, which is fixedly installed on the first movable block 1 for detecting the movement distance of the second movable block 2 relative to the first movable block 1 in the first direction Z. In this way, it is possible to confirm whether the movement distance indicated by pointer 9 is correct based on the movement distance detected by the sensor 7, which can improve the reliability of distance adjustment.

As shown in FIGS. 1 and 2, in the illustrated embodiment, a reference block 8 is installed on the second movable block 2, which has a reference plane 8a perpendicular to the first direction Z. The sensor 7 is fixedly installed on the block body 10 of the first movable block 1 and faces the reference plane 8a of the reference block 8 to detect the distance between sensor 7 and the reference plane 8a. The movement distance of the second movable block 2 relative to the first movable block 1 in the first direction Z is equal to the movement distance of the reference plane 8a relative to sensor 7. In various embodiments, the sensor 7 can be a laser distance sensor, an ultrasonic distance sensor, or an infrared distance sensor.

In an embodiment, the connector crimping device further includes a driving device, which is connected to the first movable block 1 for driving the first movable block 1 and the second movable block 2 to move together in the first direction Z. The driving device can be a cylinder, hydraulic cylinder, or electric cylinder.

Below is a brief explanation of the working process of the connector crimping device of the present invention.

Firstly, fix the connector that need to be crimped in the predetermined position;

Then, adjust the movement distance of the second movable block 2 relative to the first movable block 1 according to the crimping height of the connector to be crimped;

Finally, use a driving device (such as a cylinder) to drive the first movable block 1 and the second movable block 2 to move synchronously towards the terminal module of the connector for a predetermined distance. During this process, the second movable block 2 pushes the terminal module of the connector to crimp the connector terminal onto the cable.

As shown in FIGS. 1 to 11, in the illustrated embodiments, the first movable block 1 is the main movable block connected to the driving device, the second movable block 2 is installed on the first movable block 1 to move synchronously with the first movable block 1, and the second movable block 2 can be moved within a predetermined range relative to the first movable block 2 to adjust the crimping height of the connector crimping device, so that the connector crimping device can be suitable for connectors with different crimping heights.

In the aforementioned exemplary embodiments of the present invention, it is possible to fine tune the movement distance of the second movable block 2 relative to the first movable block 1 by rotating the installation shaft 3, thereby adjusting the crimping height of the connector crimping device, so that the connector crimping device can be suitable for different connector products with different crimping heights.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector crimping device, comprising:
a first movable block movable along a first direction and formed with a sliding slot extending along the first direction;
a second movable block installed in the sliding slot of the first movable block and movable along the sliding slot; and
an installation shaft rotatably installed to the first movable block and passing through the second movable block, the installation shaft includes a first shaft portion and a second shaft portion, the first shaft portion is rotationally mated with the first movable block and has a first central axis extending along a second direction perpendicular to the first direction, the second shaft portion is rotationally mated with the second movable block and has a second central axis extending along the second direction, the second central axis is offset by a predetermined distance from the first central axis, a movement distance of the second movable block relative to the first movable block in the first direction is adjustable by rotating the installation shaft.

2. The connector crimping device according to claim 1, wherein a pressing head is disposed on the second movable block, the pressing head presses against a terminal module of a connector to crimp a terminal of the terminal module to a cable.

3. The connector crimping device according to claim 1, wherein a second mounting hole is formed in the second movable block, the second shaft portion is rotatably fitted in the second mounting hole.

4. The connector crimping device according to claim 1, wherein the installation shaft has a front end and a rear end opposite to each other in an axial direction of the installation shaft, the first shaft portion has a first rear shaft portion at the rear end of the installation shaft and a first front shaft portion axially opposite to the first rear shaft portion, the second shaft portion is connected between the first rear shaft portion and the first front shaft portion.

5. The connector crimping device according to claim 4, wherein the first movable block includes a block body formed with a first rear mounting hole and the sliding slot, and a mounting plate formed with a first front mounting hole and fixed to the block body, the first rear shaft portion is rotatably fitted in the first rear mounting hole, the first front shaft portion is rotatably fitted in the first front mounting hole.

6. The connector crimping device according to claim 5, further comprising a rotating component fixed to the front end of the installation shaft and driving the installation shaft to rotate around the first central axis, a central axis of the front end of the installation shaft coincides with the first central axis.

7. The connector crimping device according to claim 6, further comprising a dial fixed to an outer side of the mounting plate and formed with a scale mark on a surface of the dial.

8. The connector crimping device according to claim 7, further comprising a pointer fixed to the rotating component or the installation shaft and indicating a movement distance of the second movable block relative to the first movable block, the front end of the installation shaft passes through the dial and is rotatably mated with the dial.

9. The connector crimping device according to claim 8, wherein a third mounting hole is formed in the dial, the front end of the installation shaft has a third shaft portion that is rotatably fitted in the third mounting hole, the first front shaft portion is axially connected between the third shaft portion and the second shaft portion.

10. The connector crimping device according to claim 9, wherein the front end of the installation shaft has a fourth shaft portion protruding from the third mounting hole of the dial, and an installation hole mated with the fourth shaft portion is formed in the rotating component.

11. The connector crimping device according to claim 10, wherein a first cutting plane and a second cutting plane that are mated with each other are formed on an outer peripheral surface of the fourth shaft portion and an inner peripheral surface of the installation hole, respectively, so that the rotating component cannot be rotated relative to the installation shaft.

12. The connector crimping device according to claim 11, wherein a threaded hole is formed in an end face of the fourth shaft portion, the connector crimping device further comprises a threaded connecting member passing through the rotating component and threaded into the threaded hole to fix the rotating component axially to the installation shaft.

13. The connector crimping device according to claim 8, further comprising a locking member locking the rotating component to the mounting plate or the dial, and when the installation shaft and the rotating component are rotated to a predetermined angle position relative to the dial, the locking member locks the installation shaft and the rotating component at the predetermined angle position, so that the second movable block is held at a predetermined position relative to the first movable block.

14. The connector crimping device according to claim 13, wherein a gear portion is formed on the dial, and a plurality of tooth slots on the gear portion respectively correspond to a plurality of scale marks on the dial, a locking tooth is formed on the locking member, the locking member is rotatably connected to the rotating component and can be rotated between a locking position and an unlocking position.

15. The connector crimping device according to claim 14, wherein, when the locking member is rotated to the locking position, the locking tooth is meshed with one of the tooth slots on the gear portion to lock the installation shaft and the rotating component at the predetermined angle position, and when the locking member is rotated to the unlocked position, the locking tooth is detached from the one of the tooth slots on the gear portion to allow the installation shaft and the rotating component to rotate relative to the dial.

16. The connector crimping device according to claim 9, further comprising a sensor which is fixedly installed on the first movable block to detect a movement distance of the second movable block relative to the first movable block in the first direction.

17. The connector crimping device according to claim 16, wherein a reference block is installed on the second movable block, the reference block has a reference plane perpendicular to the first direction, the sensor is fixedly installed on the block body of the first movable block and faces the reference plane of the reference block to detect a distance between the sensor and the reference plane.

18. The connector crimping device according to claim 17, wherein the movement distance of the second movable block relative to the first movable block in the first direction is equal to the movement distance of the reference plane relative to the sensor.

19. The connector crimping device according to claim 16, wherein the sensor is a laser distance sensor, an ultrasonic distance sensor, or an infrared distance sensor.

20. The connector crimping device according to claim 1, further comprising a driving device connected to the first movable block for driving the first movable block and the second movable block to move together in the first direction.
